(19) United States
(12) Patent Application Publication
(10) Pub. No.: US 2017/0167643 A1
(43) Pub. Date: Jun. 15, 2017

(54) DUAL USE HANDLE FOR SUPPLY LINES

(71) Applicant: COFLEX S.A. DE C.V., Monterrey (MX)

(72) Inventors: Andres Rodrigo Garcia Morlet, Nuevo Leon (MX); Humberto Flores-Villarreal, Col. Chapultepec (MX); Eduardo Coronado, Nuevo Leon (MX)

(21) Appl. No.: 15/237,398

(22) Filed: Aug. 15, 2016

Related U.S. Application Data
(60) Provisional application No. 62/266,150, filed on Dec. 11, 2015.

(51) Int. Cl. F16L 15/08

(52) U.S. Cl. CPC F16L 15/08

(57) ABSTRACT

The present disclosure generally relates to a handle for tightening connectors of plumbing supply lines and method for installing and using such a handle. The dual use handle includes a body having a top cavity, a bottom cavity, an aperture for receiving the plumbing supply line, and one or more handles for user grip. The top cavity is operable to receive a first end connector of the plumbing supply line, and the bottom cavity is operable to receive a second end connector of the plumbing supply line. The top and bottom cavities may be hexagonal, octagonal, or take any suitable shape and size to accommodate varying shapes and sizes of plumbing supply line end connectors.

### CROSS-REFERENCE TO RELATED APPLICATIONS

This application claims priority to U.S. Provisional Application No. 62/266,150, filed on Dec. 11, 2015, which is hereby incorporated by reference.

### BACKGROUND

Plumbing supply lines are used to connect a water supply to plumbing fixtures such as faucets, toilets, dishwashers, washing machines, steam dryers, ice makers, water filters, showers, and bathtubs, among others. Plumbing supply lines can be made from braided stainless steel, copper, plastic, or a similar material. Each end of the plumbing supply line typically includes a connector operable to connect the water supply to the plumbing fixtures. Each connector is operable to rotate freely relative to the plumbing supply line so that the plumbing supply line can be connected to the water supply and the plumbing fixture.

However, it is often difficult to tighten the connectors on both ends of the plumbing supply line with an open end wrench, an adjustable wrench, a plumbing wrench, or pipe wrench pliers because the tools often slip off the connectors. It is further difficult to use a wrench in tight spaces, particularly under bathroom and kitchen sinks. Indeed, given that at least two full (360 degrees) turns are often needed to properly tighten the connector, use of a wrench often requires that the wrench be repositioned on the connector due to obstructions, such as a wall or sink, while the connector is being tightened. Therefore, an improved apparatus and methods for addressing the above-described problems are desired.

### BRIEF SUMMARY

The present disclosure generally relates to a dual use handle for connecting a water supply outlet to a plumbing fixture with a plumbing supply line. In one exemplary embodiment, an apparatus includes a supply line having a first end connector and a second end connector, and a dual use handle having a body with a top cavity, a bottom cavity, an aperture extending through the top cavity and the bottom cavity, and one or more handle wings extending from the body. In one embodiment, the top cavity and the bottom cavity have the same diameter so as to receive end connectors of the same size. In another embodiment, the top cavity and the bottom cavity have different diameters so as to receive end connectors of different size. In addition, the top cavity and bottom cavity may be hexagonal, octagonal, or take any shape to accommodate the end connectors. The handle wings may be curved or straight-sided, or take any shape to accommodate user grip. In an additional embodiment, the body is segmented so as to help the user to identify the diameter of the top and bottom cavities.

Related methods for installing the dual use handle onto the plumbing supply line and using the dual use handle to secure the first end connector and the second end connector of the plumbing supply line onto a water supply and a plumbing fixture are also described.

### BRIEF DESCRIPTION OF THE DRAWINGS

Reference is now made to the following descriptions taken in conjunction with the accompanying drawings.

FIG. 1 illustrates a side view of an embodiment of a dual use handle installed onto a plumbing supply line having end connectors of the same size.

FIG. 2A illustrates a top perspective view of the dual use handle of FIG. 1.

FIG. 2B illustrates a bottom perspective view of the dual use handle of FIG. 1.

FIG. 2C illustrates a top view of the dual use handle of FIG. 1, whereas a bottom view of the dual use handle of FIG. 1 is identical to the top view.

FIG. 2D illustrates a front view of the dual use handle of FIG. 1.

FIG. 2E illustrates a side view of the dual use handle of FIG. 1.

FIG. 2F illustrates a cross-sectional view of the dual use handle of FIG. 1.

FIG. 2G illustrates a top perspective view of the dual use handle of FIG. 1 that has been modified to include ribs.

FIG. 3A illustrates a side view of the dual use handle of FIG. 1 operatively engaged to a first connector of the plumbing supply line of FIG. 1.

FIG. 3B illustrates a perspective view of the dual use handle of FIG. 1 operatively engaged to the first connector of the plumbing supply line of FIG. 1.

FIG. 3C illustrates a side view of the dual use handle of FIG. 1 operatively engaged to a second connector of the plumbing supply line of FIG. 1.

FIG. 4A illustrates a side view of a dual use handle installed onto a plumbing supply line having different sized end connectors.

FIG. 4B illustrates a top perspective view of the dual use handle of FIG. 4A.

FIG. 4C illustrates a bottom perspective view of the dual use handle of FIG. 4A.

FIG. 4D illustrates a top view of the dual use handle of FIG. 4A.

FIG. 4E illustrates a bottom view of the dual use handle of FIG. 4A.

FIG. 4F illustrates a cross-sectional view of the dual use handle of FIG. 4A.

FIG. 5A illustrates a top perspective view of yet another embodiment of a dual use handle having a segmented body, hexagonal cavities, and curved handle wings.

FIG. 5B illustrates a bottom perspective view of the dual use handle of FIG. 5A.

FIG. 5C illustrates a top view of the dual use handle of FIG. 5A.

FIG. 5D illustrates a bottom view of the dual use handle of FIG. 5A.

FIG. 5E illustrates a front view of the dual use handle of FIG. 5A.

FIG. 5F illustrates a side view of the dual use handle of FIG. 5A.

FIG. 6A illustrates a top perspective view of a dual use handle having octagonal cavities and curved handle wings.

FIG. 6B illustrates a bottom perspective view the dual use handle of FIG. 6A.

FIG. 6C illustrates a top perspective view of a dual use handle having a segmented body, octagonal cavities, and a segmented body.

FIG. 6D illustrates a bottom perspective view of the dual use handle of FIG. 6C.

FIG. 7A illustrates a top perspective view of a dual use handle having straight handle wings.

FIG. 7B illustrates a bottom perspective view of the dual use handle of FIG. 7A.

FIG. 7C illustrates a front view of the dual use handle of FIG. 7A.

FIG. 7D illustrates a bottom view of the dual use handle of FIG. 7A.

FIG. 8A illustrates a top perspective view of a dual use handle having straight handle wings, a segmented body, and hexagonal cavities.

FIG. 8B illustrates a bottom perspective view of the dual use handle of FIG. 8A.

FIG. 8C illustrates a top view of the dual use handle of FIG. 8A.

FIG. 8D illustrates a bottom view of the dual use handle of FIG. 8A.

FIG. 8E illustrates a front view of the dual use handle of FIG. 8A.

FIG. 8F illustrates a side view of the dual use handle of FIG. 8A.

FIG. 9A illustrates a top perspective view of a dual use handle having straight handle wings and octagonal cavities.

FIG. 9B illustrates a bottom perspective view of the dual use handle of FIG. 9A.

FIG. 9C illustrates a top view of the dual use handle of FIG. 9A.

FIG. 9D illustrates a bottom view of the dual use handle of FIG. 9A.

FIG. 10A illustrates a top perspective view of a dual use handle having straight handle wings, a segmented body, and octagonal cavities.

FIG. 10B illustrates a bottom perspective of the dual use handle of FIG. 10A.

FIG. 10C illustrates a top view of the dual use handle of FIG. 10A.

FIG. 10D illustrates a bottom view of the dual use handle of FIG. 10D.

### DETAILED DESCRIPTION

Various aspects of a dual use handle and related methods according to the present disclosure are described. It is to be understood, however, that the following explanation is merely exemplary in describing the devices and methods of the present disclosure. Accordingly, any number of reasonable and foreseeable modifications, changes, and/or substitutions are contemplated without departing from the spirit and scope of the present disclosure.

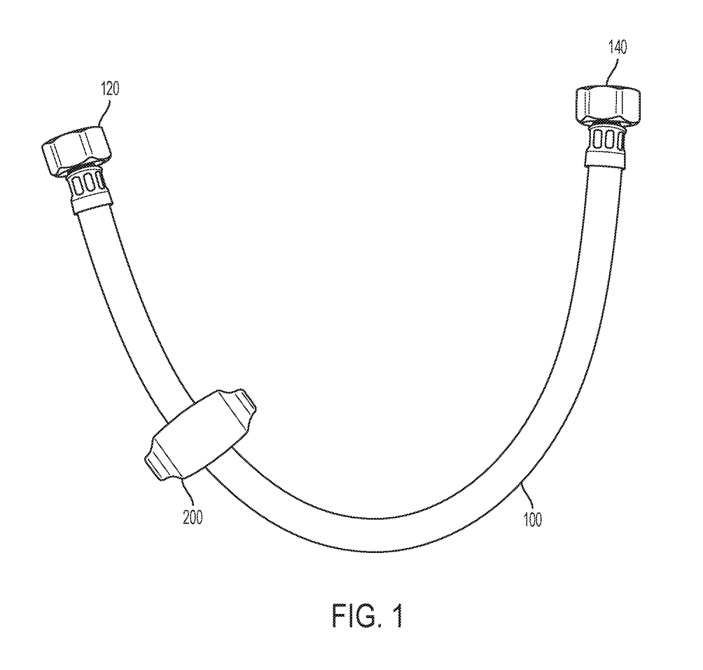

FIG. 1 illustrates a plumbing supply line 100 including a dual use handle 200 located between a first end connector 120 and a second end connector 140. The connectors 120, 140 may be formed of metal or plastic. The dual use handle 200 may come pre-assembled around the plumbing supply line 100 as illustrated. The dual use handle 200 may also be installed onto the plumbing supply line 100 by removing one of the end connectors 120 or 140 from the plumbing supply line 100, receiving the plumbing supply line 100 through an aperture 250 (discussed below) in the dual use handle 200, and then re-attaching the end connector 120 or 140 to the plumbing supply line 100.

The plumbing supply line 100 may be formed of a variety of materials. In one embodiment, the supply line 100 may be formed of an extruded rubber material, which is then coated with additional material to impart strength and aesthetic characteristics.

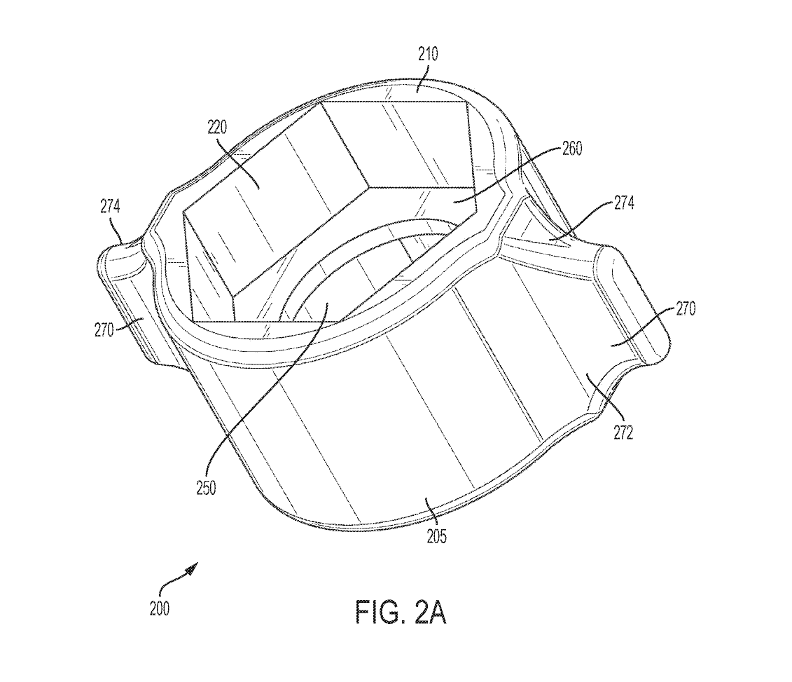

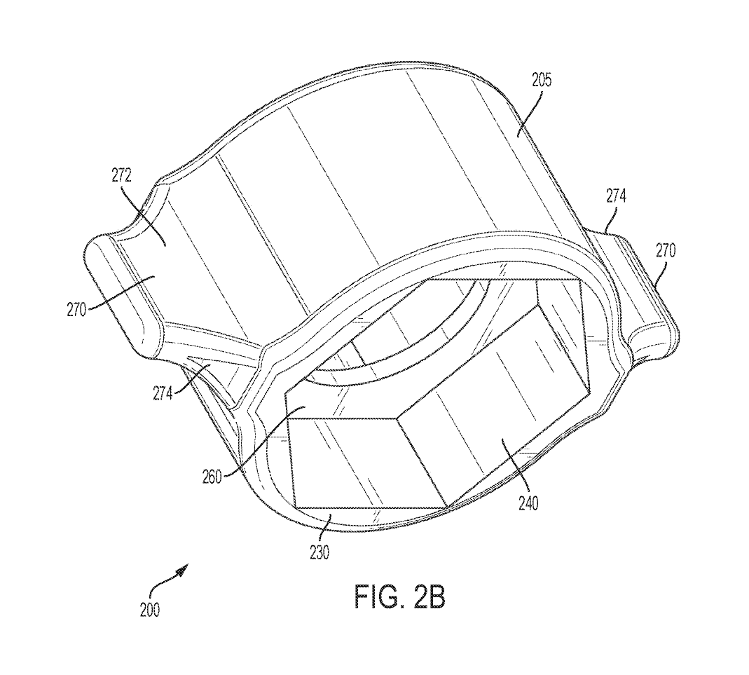

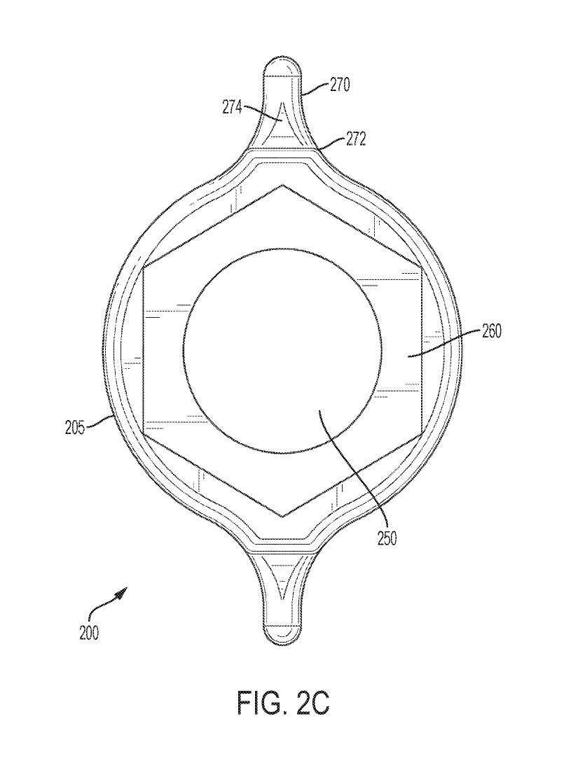

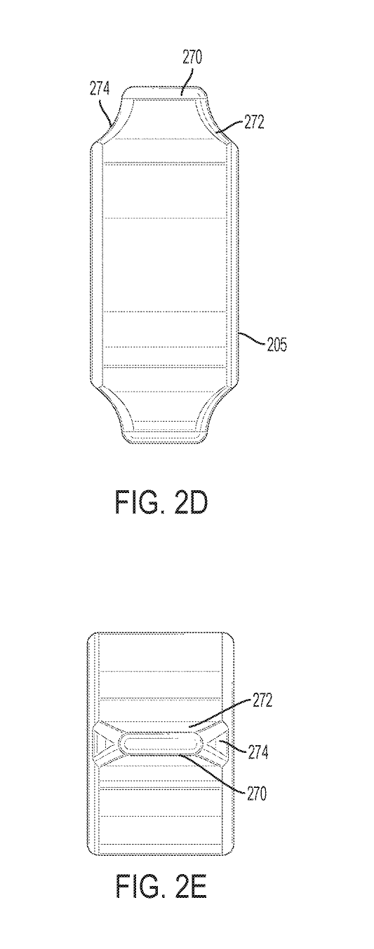

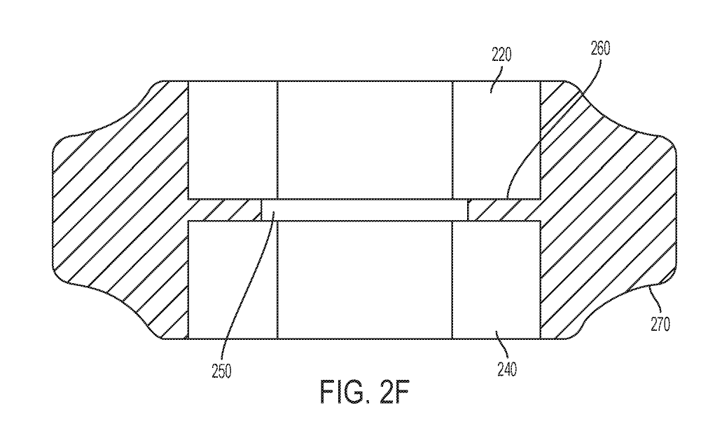

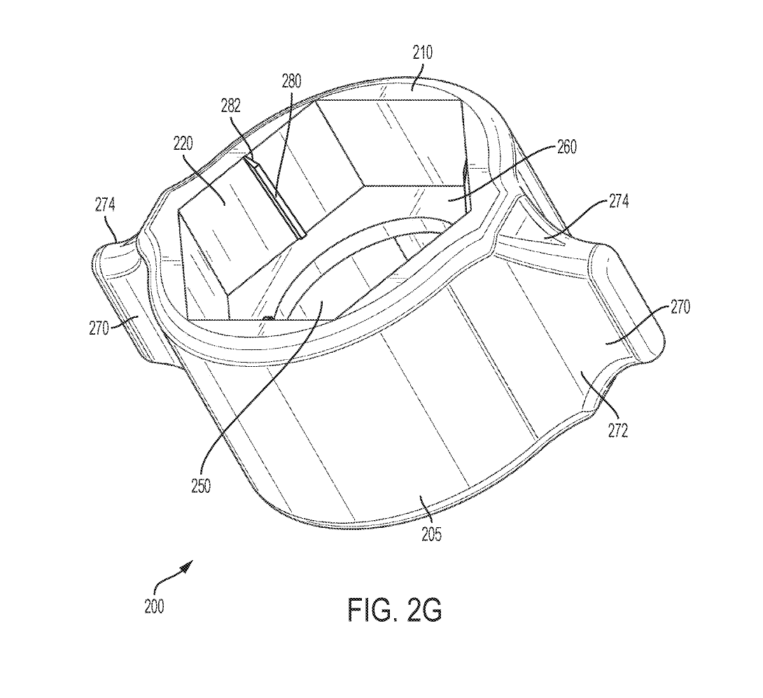

FIGS. 2A-2F illustrate an embodiment of the dual use handle 200. The dual use handle 200 may include a body 205, a top surface 210, a bottom surface 230, and an aperture 250 defined through the top surface 210 and the bottom surface 230. In the illustrated embodiment, the top surface 210 and the bottom surface 230 may be substantially circular. The body 205 may be substantially cylindrical in shape because such a cylindrical structure is comparatively easy to manufacture and integrates well with the cylindrical plumbing supply line 100 when the dual use handle 200 is installed. The aperture 250 may be circular in shape to accommodate the circular cross-section of the plumbing supply line 100. Although each of the above described parts of the dual use handle 200 was described with an exemplary corresponding shape, each part may be of any suitable shape and size to accommodate varying plumbing supply line end connectors. The aperture 250 may be circular, square, or of any suitable shape and size to receive the plumbing supply line therethrough. The body 205, top surface 210, and bottom surface 230 may also take any suitable shape and size to accommodate varying shapes and sizes of the plumbing supply line 100 and the end connectors 120 or 140.

The dual use handle 200 may further include a top cavity 220 and a bottom cavity 240. The top cavity 220 may be defined in the top surface 210 and the bottom cavity 240 may be defined in the bottom surface 230. The top cavity 220 and the bottom cavity 240 may be separated by a shoulder region 260 approximately halfway between the top surface 210 and the bottom surface 230. The top cavity 220 and the bottom cavity 240 may both be hexagonal in shape and have the same diameter. For example, the top cavity 220 and bottom cavity 240 may both be ½ inch in diameter, or ⅜ inch in diameter. The top cavity 220 and the bottom cavity 240 may also be octagonal, or take any suitable shape and size to accommodate and receive varying shapes and sizes of the first end connector 120 or the second end connector 140. In additional embodiments, the cavities 220, 240 may also be round to receive a round connector or a round connector with a knurled surface. Similarly, the longitudinal surface of the cavity 220, 240 may also be knurled. Additional embodiments, where the top cavity 220 and the bottom cavity 240 may be octagonal in shape or have different diameters from each other, are disclosed below.

The dual use handle 200 may further include one or more handle wings 270 extending from the body 205 of the dual use handle 200. The one or more handle wings 270 may be substantially trapezoidal in shape and extend from the body 205 at a base 272. The one or more handle wings 270 may include a plurality of sides 274 that may be sloped and curved so as to better receive and conform to the curvature of a user's thumb or hand while the user grips the one or more handle wings 270. The one or more handle wings 270 may further be disposed on opposite sides of the body 205 to provide even grip of the dual use handle 200. Although the dual use handle 200 as illustrated in FIGS. 2A-2F includes two trapezoidal shaped handle wings 270 with curved sides disposed on opposing sides of the body 205, the handle wings 270 may also be of rectangular shape where the sides are not curved. The dual use handle 200 may also include only a single handle wing or more than two handle wings, where the handle wings may be disposed at any suitable location on the handle body 205 to provide sufficient grip on the dual use handle 200. Therefore, any number of handle wings 270 of any suitable shape and size may be disposed at suitable locations on the body 205 to accommodate varying grip or manufacturing needs.

In operation, when the dual use handle 200 is received around the plumbing supply line 100 and the first end connector 120 and the second end connector 140 are connected to the plumbing supply line 100, the dual use handle 200 is free to slide between the ends of the plumbing supply line 100, or to latch onto either end connector with ribs as will be described. When the end connector 120 or 140 is received within the top cavity 220 or the bottom cavity 240, the one or more handle wings 270 may be used to rotate the dual use handle 200 and the end connector 120 or 140 relative to the plumbing supply line 100. Both the dual use handle 200 and both of the end connectors 120 and 140 are operable to rotate freely and about the plumbing supply line 100. Rotating the dual use handle 200 clockwise relative to the supply line 100 may tighten the connector 120 or 140 to a water supply or a plumbing fixture, while rotating the dual use handle 200 counter-clockwise relative to the plumbing supply line 100 may loosen the connector 120 or 140 from the water supply or the plumbing fixture.

FIG. 2G illustrates a modified version of the dual use handle 200. In this embodiment, the dual use handle 200 has been modified to include a plurality of longitudinally-extending ribs 280 formed along a longitudinal surface of the top cavity 220. The ribs may include a chamfered edge 282 at the portion of the rib that terminates at the top surface 210 of the dual use handle 200. The chamfered edges 282 of the ribs 280 may facilitate receipt of a corresponding connector into the top cavity 220 of the dual use handle 200. Once the connector is received into the top cavity 220, the ribs 280 are compressed. The ribs 280 allow the dual use handle 200 to latch onto either end connector with a friction fit, and prevent the dual use handle from sliding loosely along the supply line 100 if this is not desired. This is particularly useful when there is an end connector at a top part of the supply line 100 and the dual use handle 200 will inevitably slide down the supply line due to gravitational forces. While not shown, it is to be appreciated that the bottom cavity 240 (FIG. 2B) may also include a plurality of ribs formed along a longitudinal surface of the bottom cavity. Still further, although three ribs 280 are shown in FIG. 2G, it is to be appreciated that other numbers and arrangement of ribs are contemplated. For example, each longitudinal surface corresponding to one of the hexagonal sides of the top cavity 220 may include a rib or a plurality of ribs. Further, the concept of adding ribs 280 to provide a further gripping surface may apply to each and every embodiment described herein.

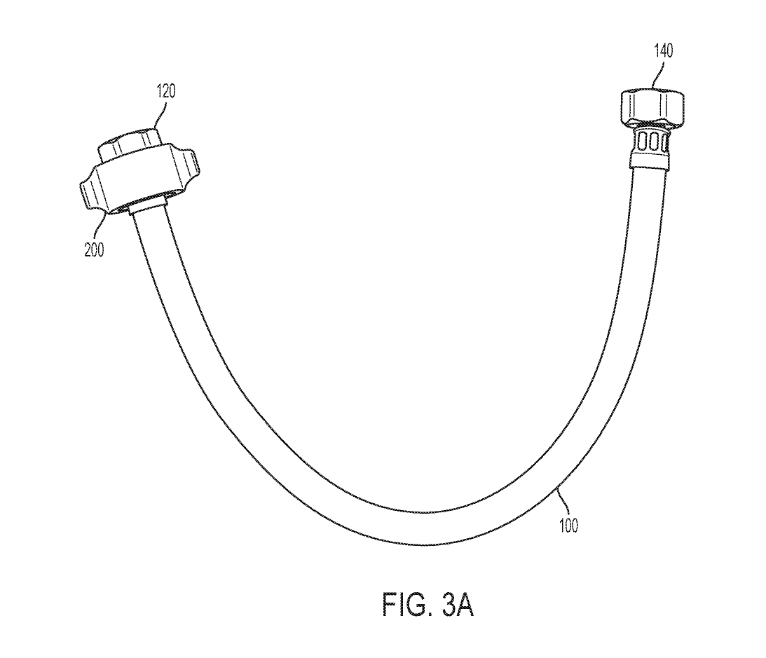

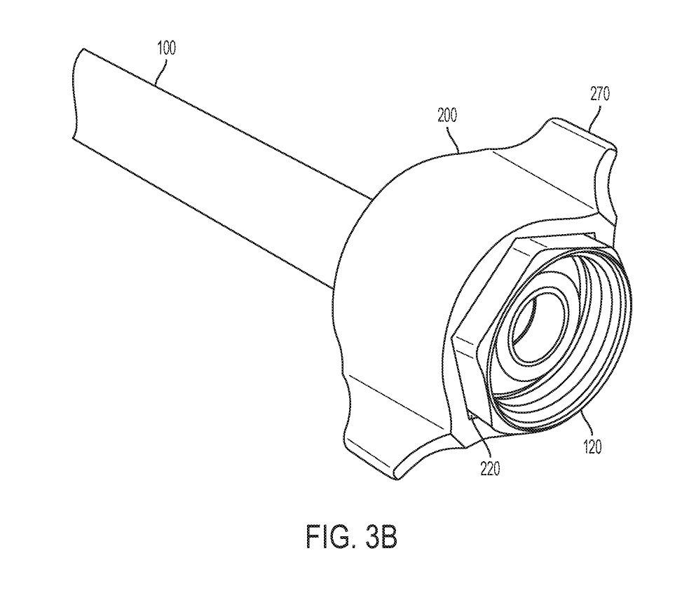

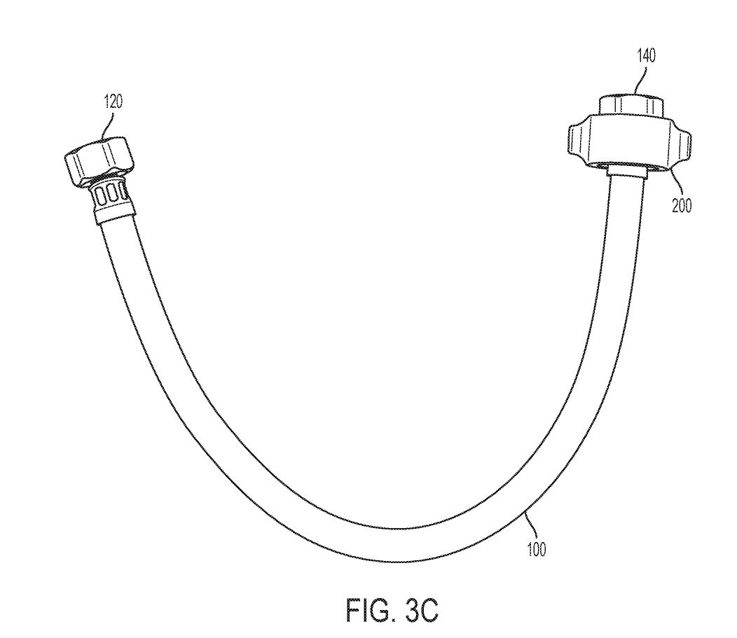

Referring to FIGS. 3A-3C, when a user wishes to tighten the first end connector 120 around the water supply or plumbing fixture, the user may slide the dual use handle 200 towards the first end connector 120 and receive the first end connector 120 in the top cavity 220. The user may then use the one or more handle wings 270 to rotate the dual use handle 200 and the first end connector 120 in a clockwise direction, tightening the first end connector 120 around the water supply or plumbing fixture.

Thereafter, the user may slide the dual use handle 200 away from the first end connector 120, leaving the first end connector 120 tightly connected to the water supply or plumbing fixture. When the user wishes to tighten the second end connector 140 around a water supply or plumbing fixture, the user may slide the dual use handle 200 towards the second end connector 140 and receive the second end connector 140 in the bottom cavity 240. The user may then use the one or more handle wings 270 to rotate the dual use handle 200 and the second end connector 140 in a clockwise direction, tightening the second end connector 140 around the water supply or plumbing fixture.

Advantageously, while tightening either the first end connector 120 or the second end connector 140, the plumbing supply line 100 does not rotate, preventing the plumbing supply line from becoming twisted or kinked. In addition, no separate tools are necessary to connect the plumbing supply line to both the water supply and the plumbing fixture. This eliminates the need for one or two separate wrenches and reduces the frustration from having wrenches slip off end connectors in tight spaces where visibility or dexterity may be limited.

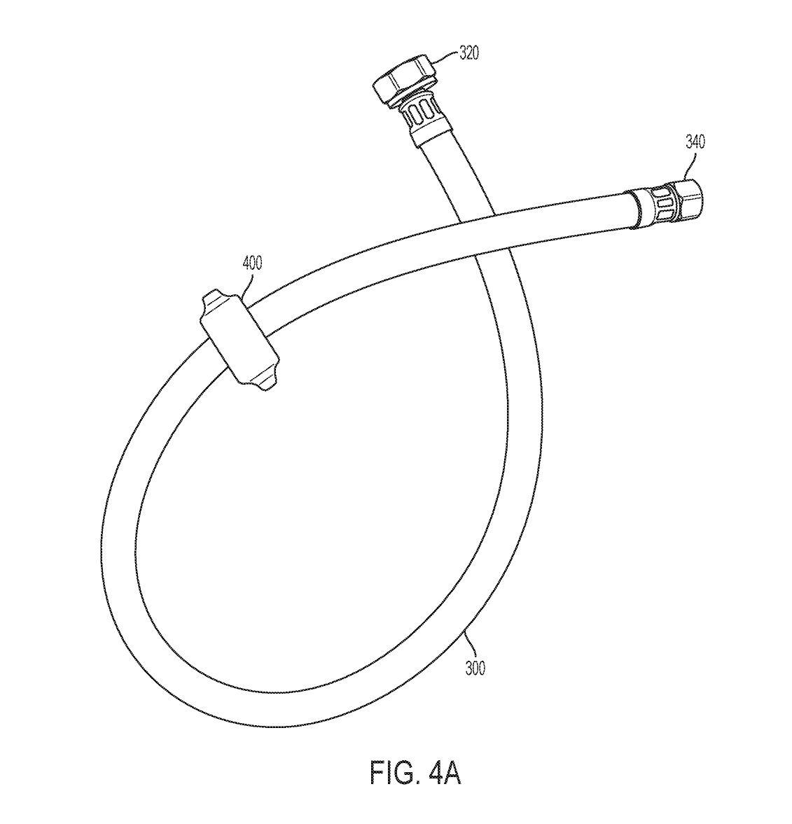

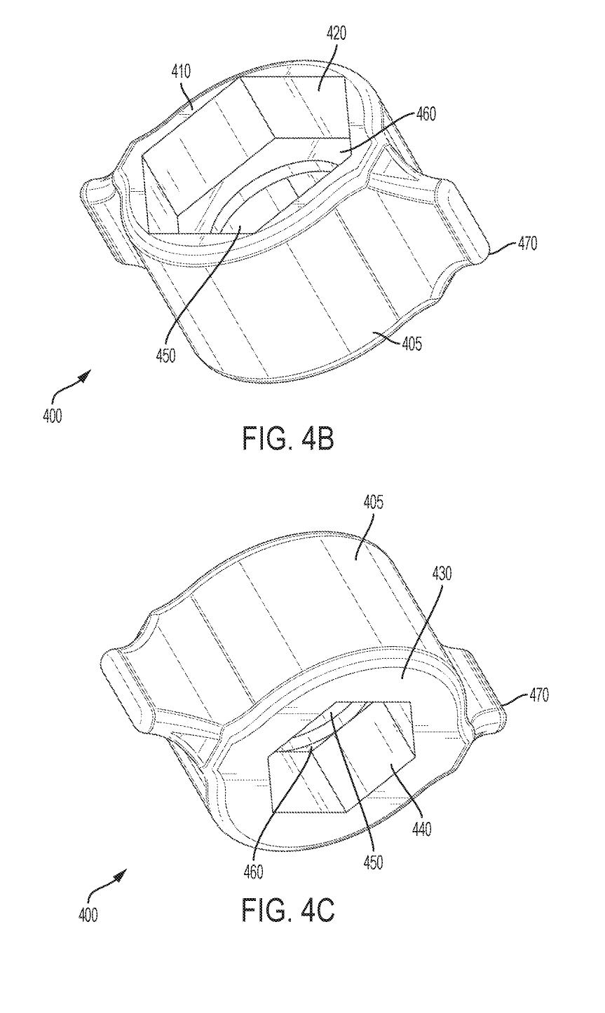

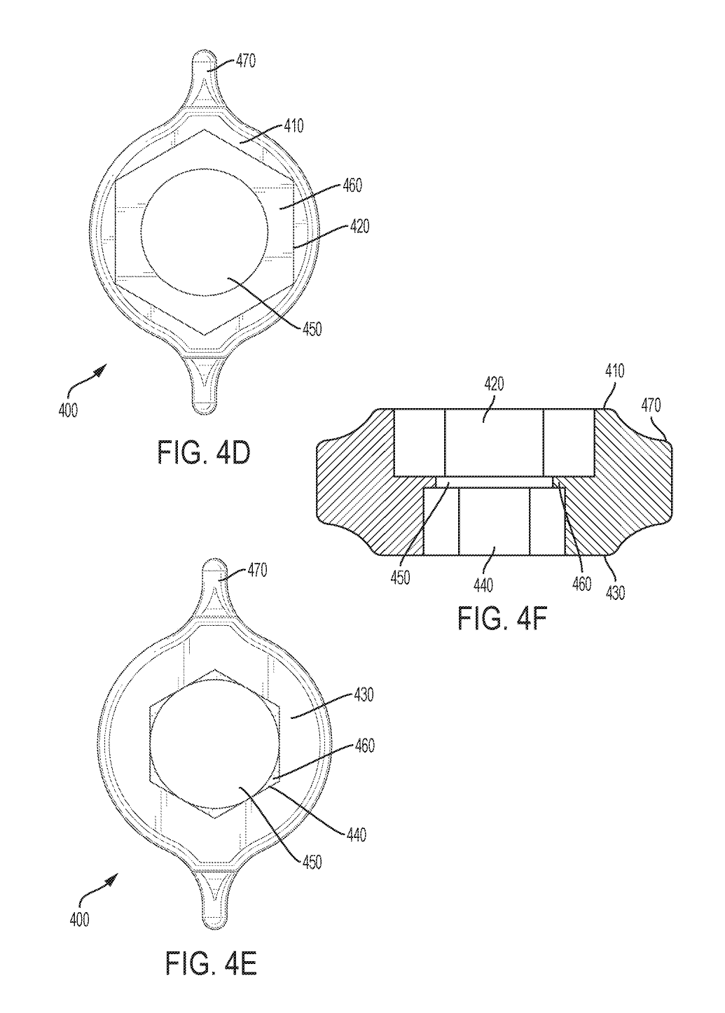

It is to be appreciated that a dual use handle may include a top cavity and a bottom cavity that may take any suitable shape and size to accommodate varying shape and size of a first and a second end connectors of a plumbing supply line. In an embodiment illustrated in FIGS. 4A-4D, a plumbing supply line 300 includes a dual use handle 400 between a first end connector 320 and a second end connector 340, where the first end connector 320 and second end connector 340 have different diameters. For example, the first end connector 320 may have a diameter of ½ inch and the second end connector 340 may have a diameter of ⅜ inch. To accommodate the different sizes of the end connectors, the dual use handle 400 may include a body 405 that includes a top cavity 420 having a first diameter operable to receive and engage the first end connector 320, and a bottom cavity 440 having a second diameter operable to receive and engage the second end connector 340. The body 405 may further include a shoulder region 460 approximately halfway between a top surface 410 and a bottom surface 430, and an aperture 450 defined through the shoulder region 460 operable to receive the plumbing supply line 300 therethrough. The dual use handle 400 may further include one or more handle wings 470 that extend from the body 405, and operate in a similar manner as the handle wings 270 described in reference to FIGS. 2A-2F.

The dual use handle 400 operate in the same manner as the dual use handle 200 of FIGS. 2A-2F disclosed above, with the exception that the dual use handle 400 is able to receive end connectors having different diameters. When a user wishes to tighten the first end connector 320 around a water supply or plumbing fixture, the user may slide the dual use handle 400 towards the first end connector 320 and receive the first end connector 320 in the top cavity 420 having the first diameter corresponding to the first end connector 320. After the user tightens the first end connector 320 around the water supply or plumbing fixture according to method described above, the user may slide the dual use handle 400 towards the second end connector 340 and receive the second end connector 340 in the bottom cavity 440 having the second diameter corresponding to the second end connector 340. The user may then tighten the second end connector 340 around the water supply or plumbing fixture according to the method described above.

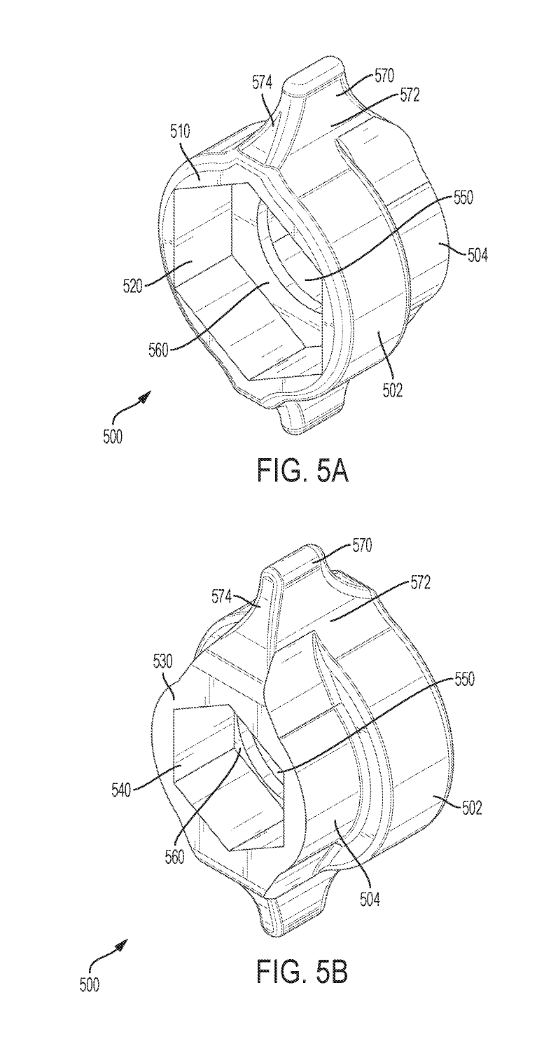

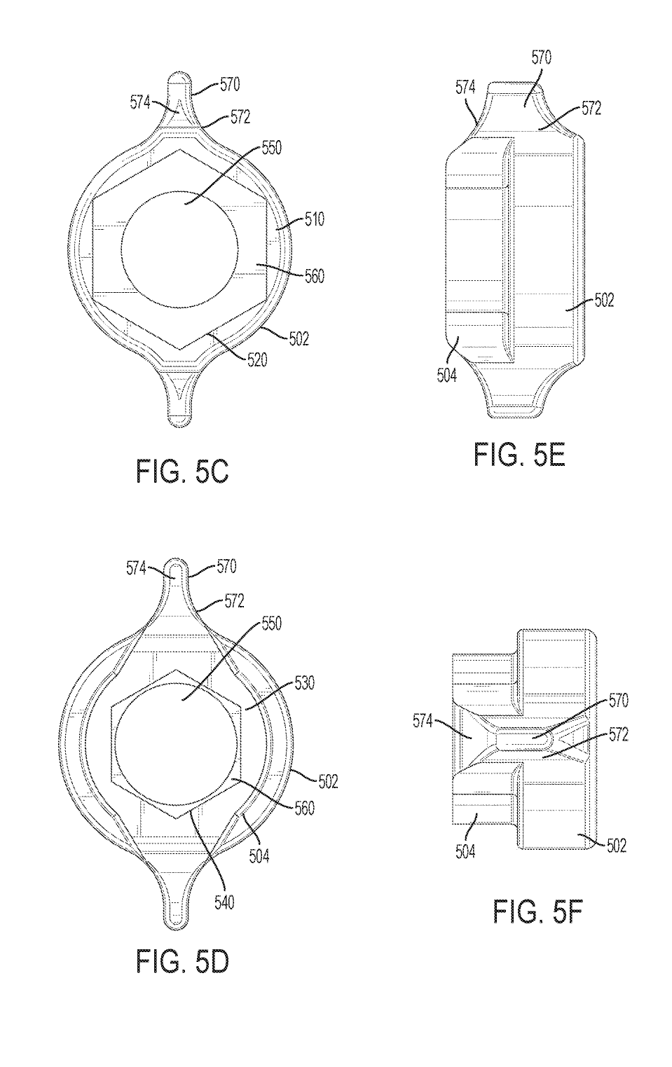

In an embodiment, a dual use handle may include a body that is segmented and sized according to the size of its receiving cavities. Referring to FIGS. 5A-5F, a dual use handle 500 may include a top body portion 502 and a bottom body portion 504. The top body portion 502 may be cylindrical in shape, and may include a top surface 510 and a height extending from the top surface 510 to approximately halfway between the top surface 510 and a bottom surface 530. The bottom body portion 504 may be cylindrical in shape, and may include the bottom surface 530 and a height extending from the bottom surface 530 to approximately halfway between the bottom surface 530 and the top surface 510. The top surface 510 may have a top surface diameter, and the bottom surface 530 may have a bottom surface diameter that is less than the top surface diameter. Accordingly, the top body portion 502 may be of a larger cylindrical shape than the bottom body portion 504. The top body portion 502 and the bottom body portion 504 may be joined at approximately the middle of the dual use handle 500, where a shoulder region 560 is located at the separation between the top body portion 502 and the bottom body portion 504.

The top body portion 502 may further enclose a top cavity 520, and the bottom body portion 504 may enclose a bottom cavity 540. The top cavity 520 may be hexagonal in shape and have a top cavity diameter. The bottom cavity 540 may be hexagonal in shape and have a bottom cavity diameter that is less than the top cavity diameter. The top cavity 520 and bottom cavity 540 may be operable to receive end connectors of different diameters. Advantageously, less material is needed to construct the dual use handle 500 of the instant embodiment because the bottom body portion 504 is small relative to the top body portion 502. Additionally, where a dual use handle includes a uniform body enclosing cavities of different sizes, a user may incorrectly install the dual use handle so that the cavities are not matched with end connectors of a corresponding size. By having a segmented body, where the smaller bottom body portion 504 encloses the smaller bottom cavity 540 and the larger top body portion 502 encloses the larger top cavity 520, the dual use handle 500 allows the user to easily determine the location of the desired sized cavity by simply identifying the correspondingly body portion.

The dual use handle 500 may further include one or more handle wings 570 that extend from both the top body portion 502 and bottom body portion 504 at a base 572. As described in reference to FIGS. 2A-2F above, the one or more handle wings 570 may be substantially trapezoidal in shape and include curved sloped sides 574. The curvature and sloping of one of the sides 574 may differ from the curvature and sloping of another of the sides 574 so as to accommodate and correspond to the different sizes of the top or bottom body portions. The one or more handle wings 570 may also be rectangular in shape, or take any suitable shape and size to accommodate varying grip or manufacturing needs.

The dual use handle 500 may also include an aperture 550 defined through the top cavity 520 and the bottom cavity 540 and operable to receive a plumbing supply line therethrough. The aperture 550 may take any suitable shape and size to accommodate varying shape and size of the plumbing supply line. The top cavity 520 and the bottom cavity 540 may also be octagonal, or take any suitable shape and size to accommodate and receive a first end connector or a second end connector of a plumbing supply line. The top body portion 502 and the bottom body portion 504 may also take any suitable shape and size to accommodate and enclose the top cavity 520 and bottom cavity 540 respectively.

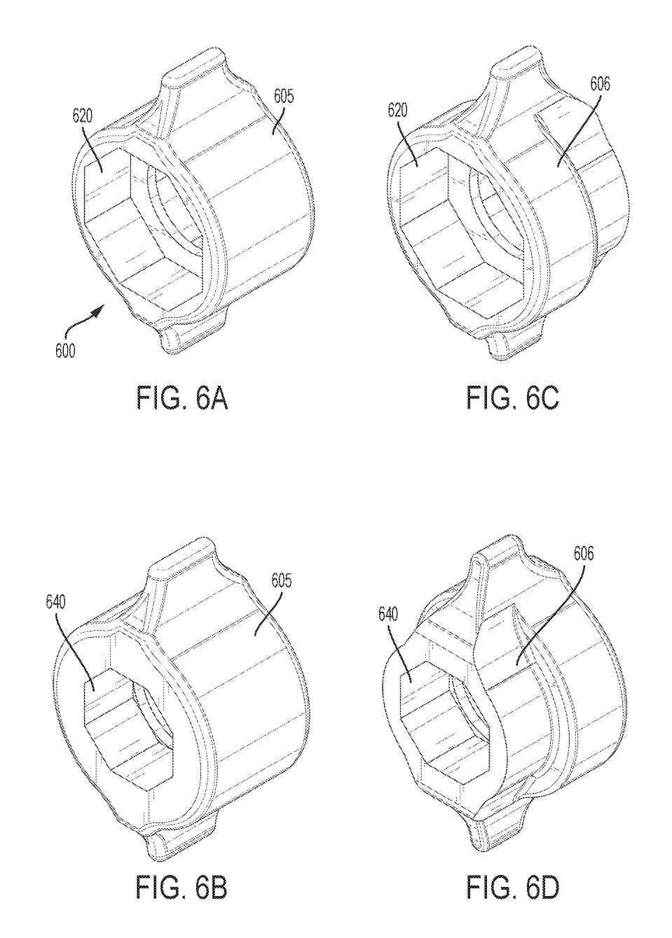

Referring now to FIGS. 6A-6D, a dual use handle 600 may include a body 605 having a top cavity 620 and a bottom cavity 640 that are octagonal-shaped. The top cavity 620 and bottom cavity 640 are operable to receive octagonal-shaped end connectors on a plumbing supply line. Octagonal-shaped connectors are often not used as they can be difficult to grip with a wrench or the like. However, the dual use plumbing handle 600 eliminates gripping issues by providing a corresponding octagonal-shaped cavity, which properly grips the connector for tightening. In this manner, octagonal connectors may be more widely used. Octagonal connectors are lighter and use less material than conventional connectors, and thus a cost savings may be achieved through use of octagonal connectors. It is notable that the dual use handle 600 may include a cylindrical body 605 (FIGS. 6A-6B) or a segmented body type 606 (FIGS. 6C-6D) depending on the cost and efficiency preferences of the manufacturer. The benefits of using a cylindrical body was described in reference to FIGS. 2A-2F, and the benefits of using a segmented body was described in reference to FIGS. 5A-5F.

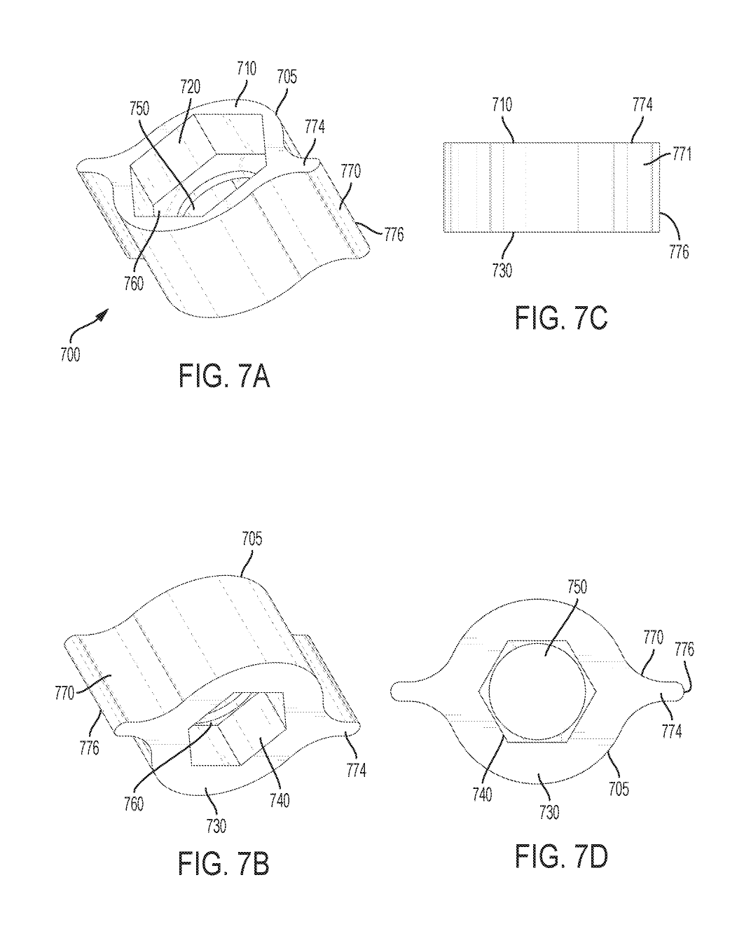

Referring now to FIGS. 7A-7D, a dual use handle may include one or more straight handle wings. In an embodiment, the dual use handle 700 may include a body 705 having a top cavity 720, a bottom cavity 740, and an aperture 750 operable to receive a plumbing supply line therethrough. The top cavity 720 and the bottom cavity 740 may be of the same size, of different size, hexagonal, octagonal, or take any suitable shape and size to accommodate varying shapes and sizes of end connectors on the plumbing supply line. The top cavity 720 and the bottom cavity 740 may be separated by a shoulder region 760 approximately halfway between a top surface 710 and a bottom surface 730. The body 705 may be substantially similar to the body 205 in reference to FIGS. 2A-2F, or the body 405 in reference to FIGS. 4B-4E.

The dual use handle 700 may further include one or more straight handle wings 770 extending from the body 705. The one or more straight handle wings 770 may be substantially rectangular in shape, where a plurality of sides 774 of the one or more straight handle wings 770 are perpendicular to a top edge 776 of the one or more straight handle wings 770. The plurality of sides 774 of the straight handle wings 770 may further be on the same plane as the top surface 710 and the bottom surface 730. Referring specifically to FIG. 7D, the one or more straight handle wings 770 extend from the body 705 in a curved fashion. Advantageously, this curvature makes it easier for a user to comfortably grip the one or more straight handle wings 770. The one or more straight handle wings 770 further includes a large surface area for which the user may grip onto, and the straight handle wing 770 may be comparatively easier to manufacture than the curved handle wings as illustrated in FIGS. 2A-2F.

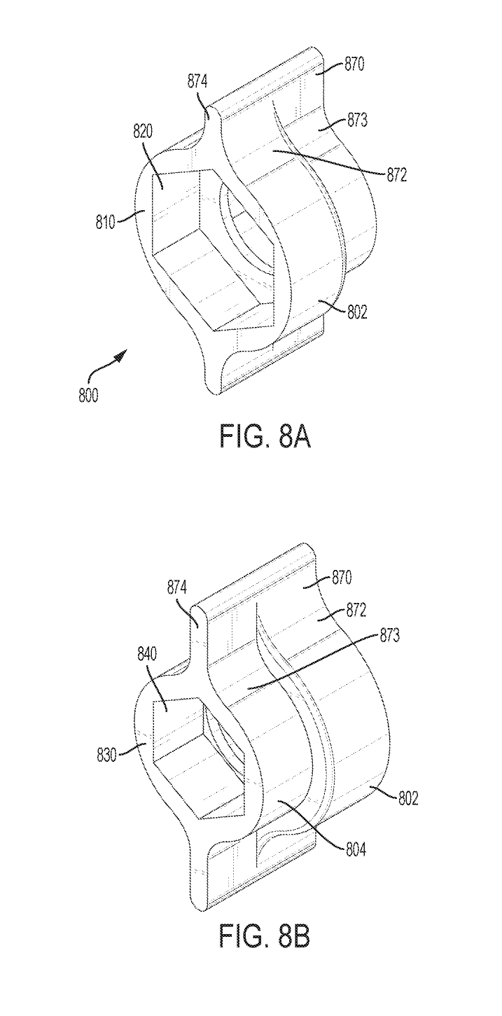

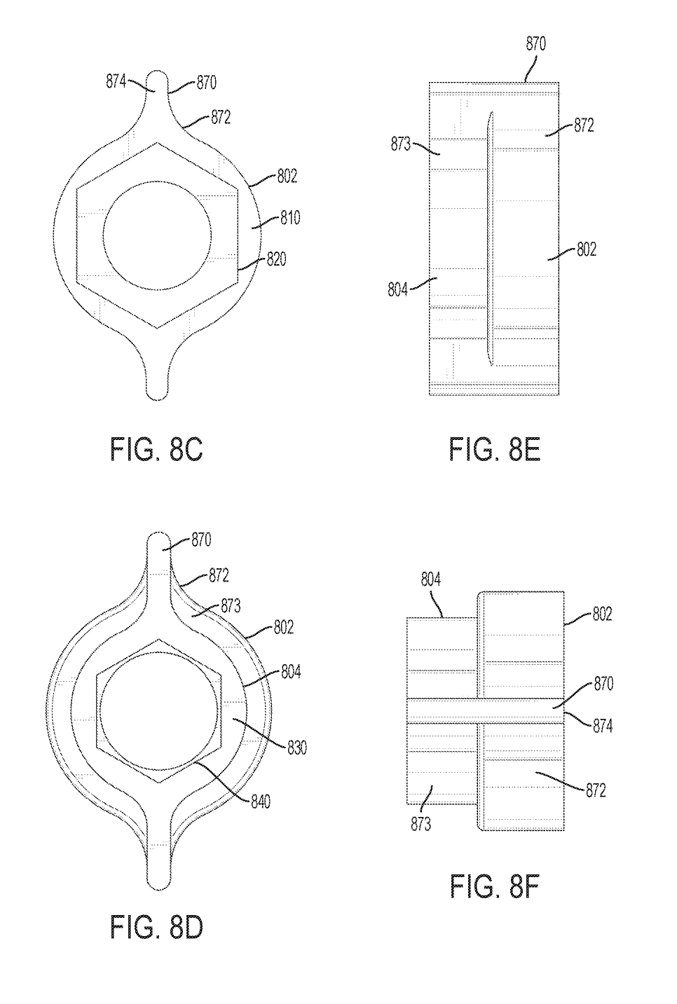

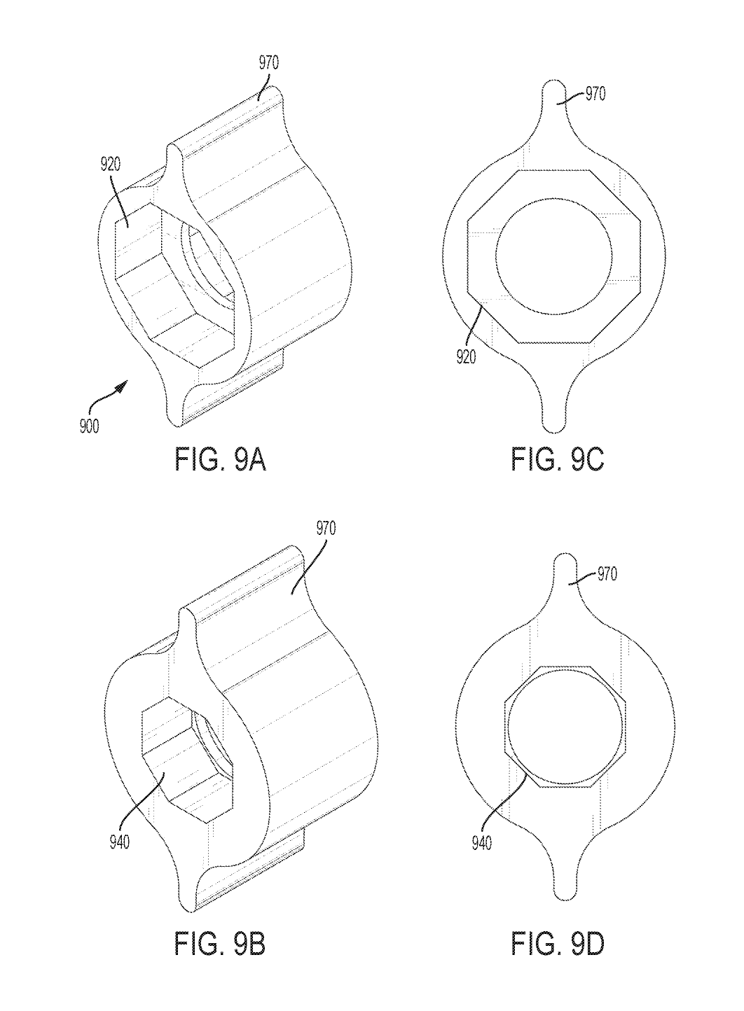

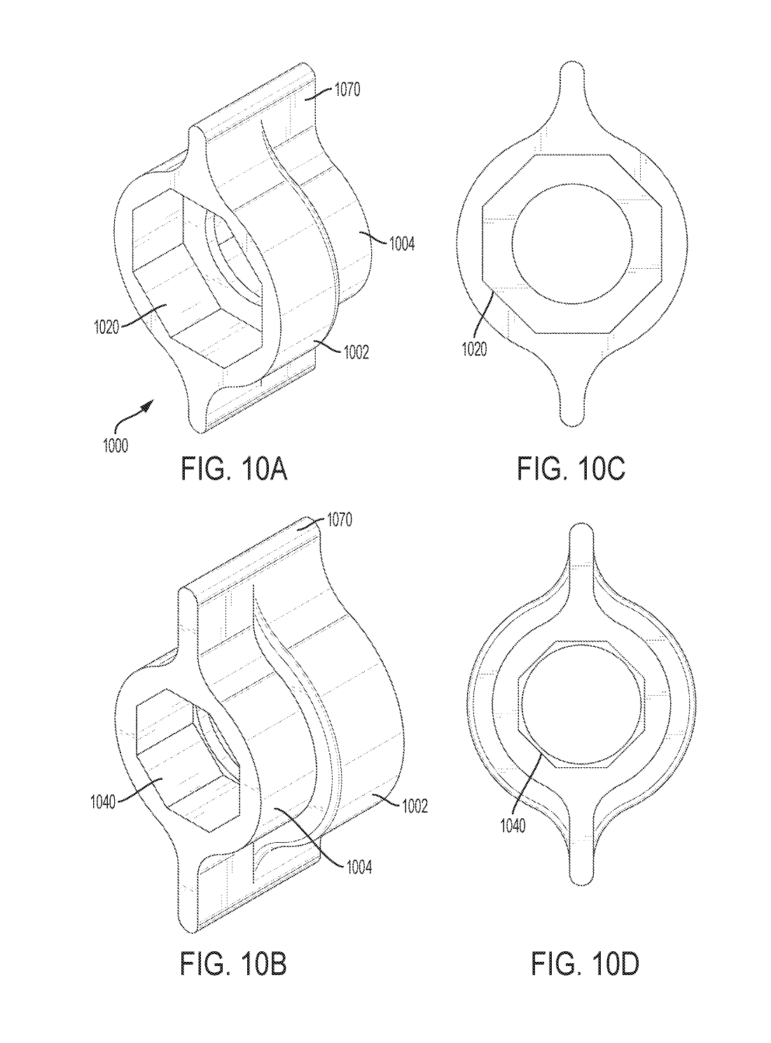

While various embodiments of a dual use handle apparatus and related methods of tightening the plumbing supply line to the water supply or plumbing fixtures using the dual use handle have been described above, it should be understood that they have been presented by way of example only, and not limitation. A dual use handle may include different elements from different embodiments described above so as to incorporate the advantages presented by the different elements. For example, referring to FIGS. 8A-8F, a dual use handle 800 may include a top body portion 802 enclosing a top cavity 820 and a bottom body portion 804 enclosing a bottom cavity 840. The top body portion 802 and the bottom body portion 804 may be substantially similar to top body portion 502 and bottom body portion 504 in FIGS. 5A-5F, with the exception that dual use handle 800 may include a one or more straight handle wings 870 substantially similar to the one or more straight handle wings 770 illustrated in FIGS. 7A-7E. The one or more straight handle wings 870 may extend from both the top body portion 802 and the bottom body portion 804 at a top base 872 and a bottom base 873 respectively. The one or more straight handle wings 870 may further include straight sides 874 that are parallel to and are on the same plane as a top surface 810 and a bottom surface 830. The dual use handle 800, which combines the segmented body of dual use handle 500 of FIG. 5A with the straight handle wings of FIG. 7A, may be desirable because the segmented body requires less materials to produce and the straight handle wings are easier to manufacture. Still further, referring to FIGS. 9A-9D and 10A-10D, a dual use handle may include cavities that are octagonal in shape. In one embodiment, a dual use handle 900 may include a top cavity 920, a bottom cavity 940, and one or more straight handle wings 970. The dual use handle 900 may be substantially similar to the dual use handle 700 as illustrated in FIGS. 7A-7E, except that the top cavity 920 and the bottom cavity 940 of dual use handle 900 are octagonal in shape. In another embodiment, a dual use handle 1000 may include a top body portion 1002 enclosing a top cavity 1020, a bottom body portion 1004 enclosing a bottom cavity 1040, and one or more straight handle wings 1070. The dual use handle 1000 may be substantially similar to the dual use handle 800 as illustrated in FIGS. 8A-8F, except that the top cavity 1020 and the bottom cavity 1040 are octagonal in shape. The dual use handles 900 and 1000, operable to use octagonal shaped cavities to receive octagonal shaped connectors, may be desirable because octagonal connectors are lighter and use less material than conventional connectors. Thus, the breadth and scope of the invention(s) should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

1. An apparatus comprising:
a supply line including a first end connector and a second end connector;
a dual use handle including a body having a top surface with a top cavity defined therein, a bottom surface with a bottom cavity defined therein, an aperture defined through the top surface and the bottom surface, and one or more handle wings extending from the body,
wherein the first end connector is operable to be received within the top cavity.

2. The apparatus of claim 1, wherein the dual use handle is operable to rotate the first end connector relative to the supply line.

3. The apparatus of claim 1, wherein the supply line is operable to be received within the aperture of the dual use handle and the dual use handle is operable to slide freely along a length of the supply line.

4. The apparatus of claim 1, wherein the second end connector is operable to be received within the bottom cavity and the dual use handle is operable to rotate the second end connector relative to the supply line.

5. The apparatus of claim 1, wherein the top cavity is substantially hexagonal in shape and encircles the aperture.

6. The apparatus of claim 1, wherein the top cavity is substantially octagonal in shape and encircles the aperture.

7. The apparatus of claim 5, wherein the bottom cavity is substantially hexagonal in shape and encircles the aperture.

8. The apparatus of claim 5, wherein the bottom cavity is substantially octagonal in shape and encircles the aperture.

9. The apparatus of claim 1, wherein the top cavity and the bottom cavity have the same diameter.

10. The apparatus of claim 1, wherein the top cavity and the bottom cavity have different diameters.

11. The apparatus of claim 1, wherein the top surface and the bottom surface have the same diameter.

12. The apparatus of claim 1, wherein the top surface and the bottom surface have different diameters.

13. The apparatus of claim 1, wherein the one or more handle wings are substantially trapezoidal in shape and include a plurality of curved sides.

14. The apparatus of claim 1, wherein the one or more handle wings are substantially rectangular in shape and include a plurality of straight sides.

15. The apparatus of claim 1, further comprising a shoulder region disposed between the top surface and the bottom surface.

16. The apparatus of claim 1, wherein the top cavity includes one or more ribs formed along a surface thereof.

17. The apparatus of claim 1, wherein the bottom cavity includes one or more ribs formed along a surface thereof.

18. A method for tightening connectors of a plumbing supply line, comprising:
providing a dual use handle, the dual use handle comprising:
a top surface with a top cavity defined therein;
a bottom surface with a bottom cavity defined therein;
an aperture defined through the top surface and the bottom surface; and
one or more handle wings extending from the body; and
receiving a first end connector of the plumbing supply line in the top cavity;
rotating the dual use handle and the first end connector so as to tighten the first end connector.

19. The method of claim 18, further comprising:
sliding the dual use handle away from the first end connector and towards a second end connector of the plumbing supply line;
receiving the second end connector in the bottom cavity;
rotating the dual use handle and the second end connector so as to tighten the second end connector.

20. The method of claim 18, further comprising:
installing the dual use handle onto the plumbing supply line by removing one of the first and second end connectors from the plumbing supply line, receiving the plumbing supply line through the aperture, and re-attaching the first or second end connector to the plumbing supply line.

21. The method of claim 18, wherein the top cavity includes one or more ribs formed along a longitudinal surface of the top cavity, the method further comprising using the ribs to facilitate latching of the dual use handle onto the first end connector via a friction fit when it is received in the top cavity to thereby retain the first end connector within the top cavity.

22. An apparatus comprising:
a dual use handle including a body having a top surface with a top cavity defined therein, a bottom surface with a bottom cavity defined therein, and an aperture defined through the top surface and the bottom surface, and one or more handle wings extending from the top body and the bottom body,
wherein the dual use handle is operable to receive a connector within the top cavity and a connector within the bottom cavity.

23. The apparatus of claim 22, wherein the top surface has a first diameter and the bottom surface has a second diameter that is different from the first diameter.

24. The apparatus of claim 22, wherein the top cavity includes one or more ribs formed along a surface thereof.

25. The apparatus of claim 22, wherein the bottom cavity includes one or more ribs formed along a surface thereof.
